(19) United States
(12) Patent Application Publication
(10) Pub. No.: US 2003/0216213 A1
(43) Pub. Date: Nov. 20, 2003

(54) Reduction gear and product group of reduction gears

(76) Inventor: Akira Yamamoto, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/400,063

(22) Filed: Mar. 27, 2003

(30) Foreign Application Priority Data
Mar. 27, 2002 (JP) 2002-88566

(51) Int. Cl. F16H 37/06

(52) U.S. Cl. 475/330

(57) ABSTRACT

A reduction gear and a series of reduction gears are provided, which have concentric input and output shafts, are capable of securing a large space at the center, and are highly efficient with the ability to fully cover a region with a reduction ratio of 1/5 (or 1/2) to 1/30 as needed. An output shaft is made hollow, and an input shaft and the output shaft are placed coaxially. A reduction mechanism portion of a high-side reduction gear group includes an input shaft, a high-side carrier, high-side first and second planetary gears, high-side first and second internal gears, and an output shaft. The high-side first and second planetary gears have a trochoid tooth profile as the tooth profile, whereas the first and second internal gears respectively engaged with the first and second planetary gears having the trochoid tooth profile have an arc tooth profile.

### BACKGROUND OF THE INVENTION

1. Field of the Invention

The present invention relates to a reduction gear and a series of reduction gears, and more particularly to a reduction gear and a series of reduction gears capable of ensuring a region of a low reduction ratio of 1/2 to 1/30 with high efficiency while securing a large space at the center.

2. Description of the Related Art

Generally, a reduction gear includes an input shaft, a reduction mechanism portion that slows down rotations of the input shaft, and an output shaft that outputs rotations slowed down by the reduction mechanism portion to a machine at the other end. In order to meet a need that varies from customer to customer, manufacturers providing reduction gears prepare a wide variety of types of reduction gears with different torques or reduction ratios as a series (a product group). The arrangement or the construction of a series has an extensive influence on the characteristics and the cost of the entire series, and consequently, it has a direct influence on the appeal and the cost of individual reduction gears as a product.

In the field of a speed reducing apparatus, such as a reduction gear and a geared motor, it is necessary, in some cases, to draw a tube, a wire, a hose, etc. to a machine (or facility) at the other end placed at the output end from behind the speed reducing apparatus. In such a case, it is most conventional to route the tube or the like by going around the speed reducing apparatus. However, there is known a type with which the tube or the like is routed directly through the interior of the speed reducing apparatus (for example, see Japanese Patent Laid-Open Publication No. Hei 8-226498), and there is a reasonable need.

Hence, even in the reduction gear of a hollow type, it is necessary to develop a reduction gear that can be adapted to various applications requested from the customers, and prepare a series of reduction gears (reduction gear group) each having a slightly different torque or reduction ratio.

However, for each reduction gear disclosed in Japanese Patent Laid-Open Publication No. Hei 8-226498, for example, as an essential prerequisite to provide a through hole along the axial center of the reduction gear, it is necessary to arrange in such a manner that the input and output shafts are placed to cross at right angles, or the motor is placed in advance at a position to go around the axial center of the reduction mechanism. Hence, the placement of the motor does not coincide with the center of the reduction mechanism, and in particular, the reduction gear cannot be made compact in the radial direction.

Incidentally, as a reduction gear in which the input and output shafts are concentric and the output shaft can be hollow, there is known a wobbling inner gearing planetary reduction gear called a K-H-V type.

As is shown by way of the skeleton of a structure in FIG. 6A, a reduction gear GI of this type includes an input shaft 500, an external gear (planetary gear) 504 allowed to wobble eccentrically about the input shaft 500, and an internal gear 506 internally engaged with the external gear 504, and (in general) components equivalent to rotations of the external gear 504 on its axis are taken out to a carrier end 508 by fixing the internal gear 506, with which an output shaft 502 is rotated. The K-H-V type reduction gear, however, is generally used in a region of a high reduction ratio where the reduction ratio is higher than approximately 1/30, and in order to achieve a reduction ratio in a region lower than the above specified region, not only a special design is needed, but also an eccentric quantity e of the external gear 504 is increased, which poses a problem that it becomes more difficult to form a large hollow space at the center.

On the other hand, as a reduction gear arranged in such a manner that the input and output shafts are concentric and in such a manner to cover a region of a low reduction ratio where a reduction ratio is lower than 1/30, there is known a planetary reduction gear of a so-called 2K-H-I type. This reduction gear is generally referred to as a simple planetary reduction gear, and the skeleton of a structure alone is shown in FIG. 6B because the structure itself is well known.

In the case of applying this structure to a reduction gear, a first shaft 602 linked to a sun gear 604 is generally used as the input shaft, while either a carrier 606 or a second shaft 610 linked to an internal gear 608 is used as the output shaft. With a reduction gear G2 of this type, however, the upper limit of a reduction ratio as a single reduction gear is 1/5 to 1/7 approximately, and in order to obtain a reduction ratio higher than the limit, a double reduction gear is needed. Hence, the dimension in the axial direction is increased, which in turn increases the cost. Further, as is apparent from the drawing that it is necessary for this arrangement to make the sun gear 604 smaller in increasing a reduction ratio, which makes it difficult to form a large hollow portion at the center for the structural reason.

A so-called 2K-H-III type is known as a reduction mechanism that can secure a hollow space at the center, in particular, a hollow space needed to make the output shaft hollow with comparative ease. FIG. 6C shows the skeleton of a structure of a reduction gear G3 of this type. The reduction gear G3 includes a first shaft 700, a carrier 704 linked to the first shaft 700, a first planetary gear 708 and a second planetary gear 706 both supported rotatably by the carrier 704, a first internal gear 710 engaged with the first planetary gear 708, a second internal gear 712 engaged with the second planetary gear 706, an output shaft 702, and second and third shafts 714 and 716 linked to the first and second internal gears 710 and 712, respectively. The reduction gear G3 has a complicated structure, but in turn it has an advantage that a reduction (step-up) gear can be formed in various manners. Moreover, as is apparent from the drawing, the reduction gear G3 of the 2K-H-III type omits a sun gear, and therefore, it is relatively easy to from a large hallow portion at the center. However, the reduction gear G3 of the 2K-H-III type has a narrow region where a reduction ratio can be arranged, and it is practically impossible to cover the entire region from 1/2 to 1/30 with the 2K-H-III type.

Further, when the reduction mechanism of the 2K-H-III type is formed through the use of a typical involute tooth profile, the tooth flank is often worn out at an early stage due to a high slipping ratio, and the efficiency is not necessarily high. In addition, strict accuracy control and a special structure are needed in order to manufacture a reduction gear of low backlash specifications, which is one of the reasons that increase the cost.

Besides the foregoing types, various other arrangements are known as a structure using a planetary gear mechanism, such as a 2K-H-II type and a 2K-H-IV type. However, each has good and bad points as an arrangement of a reduction gear or a series of reduction gears that achieves an object of the invention.

### SUMMARY OF THE INVENTION

The invention was devised in view of the conventional problems, and therefore, has an object to provide a reduction gear and a series (a product group) of reduction gears having concentric input and output shafts, capable of securing a large hollow space at the center, and, in particular, being highly efficient with the ability to fully cover a region with a reduction ratio of 1/2 to 1/30 as needed.

The invention solves these problems with a reduction gear, including: an input shaft; a reduction mechanism portion for slowing down a rotation of the input shaft; and an output shaft for outputting the rotation slowed down by the reduction mechanism portion to a mating machine, wherein: the output shaft is hollow; the input shaft and the output shaft are placed coaxially; the reduction mechanism portion comprises a planetary gear mechanism including a carrier linked to the input shaft, first and second planetary gears supported by the carrier to be rotatable at a same rotational speed, a first internal gear engaged with the first planetary gear and maintained in a fixed state, and a second internal gear engaged with the second planetary gear and linked to the output shaft; and at least one of the first and second planetary gears has a trochoid tooth profile as a tooth profile, and the gear engaged with the planetary gear having the trochoid tooth profile has an arc tooth profile.

The invention also solves these problems with a reduction gear, including: an input shaft; a reduction mechanism portion for slowing down a rotation of the input shaft; and an output shaft for outputting the rotation slowed down by the reduction mechanism portion to a machine at the other end, wherein: the output shaft is hollow; the input shaft and the output shaft are placed coaxially; the reduction mechanism portion is composed of a planetary gear mechanism including a carrier linked to the input shaft, first and second planetary gears supported by the carrier to be rotatable at a same rotational speed, a first internal gear engaged with the first planetary gear and maintained in a fixed state, and a second internal gear engaged with the second planetary gear and linked to the output shaft; and at least one of the first and second planetary gears has an arc tooth profile as a tooth profile, and the gear engaged with the planetary gear having the arc tooth profile has a trochoid tooth profile.

In the invention, these problems are solved by basically having a reduction mechanism of a so-called 2K-H-III type in order to achieve the region of a high reduction ratio (for example, 1/30 to 1/5), and by having a trochoid tooth profile as a tooth profile of at least one of the first and second planetary gears and having an arc tooth profile as a tooth profile of the gear engaged with the planetary gear having the trochoid tooth profile, or, by having an arc tooth profile as a tooth profile of at least one of the first and second planetary gears and having a trochoid tooth profile as a tooth profile of the gear engaged with the planetary gear having the arc tooth profile.

In other words, by arranging in this manner, not only can a wide hollow space be secured around the input and output shafts, but also a reduction gear (and a product group of reduction gears) capable of covering a broad region of reduction ratios can be provided.

Also, it is possible to lessen a frictional loss caused by engagement between the planetary gear and the gear engaged with this planetary gear in comparison with the case of having the involute tooth profile, and as a consequence, efficiency of the overall reduction mechanism can be improved.

In other words, because speed reduction efficiency of the overall speed reducing apparatus of the 2K-H type is highly susceptible to the working efficiency between the driving-end gear and the planetary gear engaged with the driving-end gear, and the working efficiency of the output-end gear and the planetary gear engaged with the output-end gear, it is possible to improve the efficiency of the overall speed reducing apparatus by improving each working efficiency. A detailed explanation in this regard will be given in the description of an embodiment of the invention below.

Incidentally, when rotatable pins are used as the arc tooth profile, slipping in engagement can be absorbed more, and therefore, it is possible to manufacture a highly efficient reduction gear with high accuracy such that deteriorates little over time due to friction or the like even on a low backlash design.

Also, by arranging in such a manner that the first and second planetary gears have an equal number of teeth, the first and second internal gears respectively engaged with the first and second planetary gears have different numbers of teeth, and a set of the first planetary gear and the first internal gear and a set of the second planetary gear and the second internal gear have different tooth profiles, it is possible to form a so-called magical gear mechanism even when the arc tooth profile and the trochoid tooth profile are adopted, and a large reduction ratio can be thus achieved.

Further, the invention can be developed to a series (a product group) of reduction gears including a reduction gear as a component, the reduction gear including: an input shaft; a reduction mechanism portion for slowing down a rotation of the input shaft; and an output shaft for outputting the rotation slowed down by the reduction mechanism portion to a machine at the other end, wherein: the output shaft is hollow; the input shaft and the output shaft are placed coaxially; the series is divided into a high-side reduction gear group and a low-side reduction gear group responsible for a region of a high reduction ratio and a region of a low reduction ratio, respectively; the reduction mechanism portion of the high-side reduction gear group is composed of a high-side planetary gear mechanism including a high-side carrier linked to the input shaft, high-side first and second planetary gears supported by the high-side carrier to be rotatable at a same rotational speed, a high-side first internal gear engaged with the high-side first planetary gear and maintained in a fixed state, and a high-side second internal gear engaged with the high-side second planetary gear and linked to the output shaft, at least one of the high-side first and second planetary gears having an arc tooth profile as a tooth profile, the gear engaged with the planetary gear having the arc tooth profile having a trochoid tooth profile; and the reduction mechanism portion of the low-side reduction gear group is composed of a low-side planetary gear mechanism including a low-side sun gear linked to the input shaft, a low-side carrier maintained in a fixed state, a low-side first planetary gear supported rotatably by the low-side carrier and engaged with the sun gear, and a low-side second planetary gear also supported rotatably by the low-side carrier and rotating at a same rotational speed of the low-side first planetary gear, and a low-side internal gear engaged with the low-side second planetary gear and linked to the output shaft.

To be more concrete, by arranging in such a manner that the high-side reduction gear group is responsible for the region where a reduction ratio is 1/30 to 1/5 and a low-side reduction gear group is responsible for the region where a reduction ratio is 1/5 to 1/2, it is possible to achieve a series having a broad region of reduction ratios from 1/2 to 1/30.

Also, by forming a series of reduction gears in such a manner that at least one set of components selected from combinations including the output shafts in each group, the high-side second internal gear and the low-side internal gear, the high-side carrier and the low-side carrier, the high-side first planetary gear and the low-side first planetary gear, and the high-side second planetary gear and the low-side second planetary gear are designed to be used commonly in at least a part of reduction gears belonging to the high-side reduction gear group and a part of reduction gears belonging to the low-side reduction gear group, an increase in variety of components can be minimized, and it is thus possible to design a series with low inventory costs.

### BRIEF DESCRIPTION OF THE DRAWINGS

FIG. 1 is a cross section taken along the line I-I of FIG. 2, showing an overall arrangement of a high-side reduction gear according to one embodiment of the invention;

FIG. 2 is a front view showing a structure of the high-side reduction gear when viewed from a direction II indicated by an arrow on the left side of FIG. 1;

FIG. 3 is a cross section taken along the line III-III of FIG. 4, showing an overall arrangement of a low-side reduction gear according to one embodiment of the invention;

FIG. 4 is a front view showing a structure of the low-side reduction gear when viewed from a direction IV indicated by an arrow on the left side of FIG. 3;

FIG. 5 is a view showing a skeleton of a reduction mechanism of a 2K-H type; and

FIG. 6A through FIG. 6C are views showing skeletons of reduction mechanisms of a K-H-V type, a 2K-H-I type, and a 2K-H-III type, respectively.

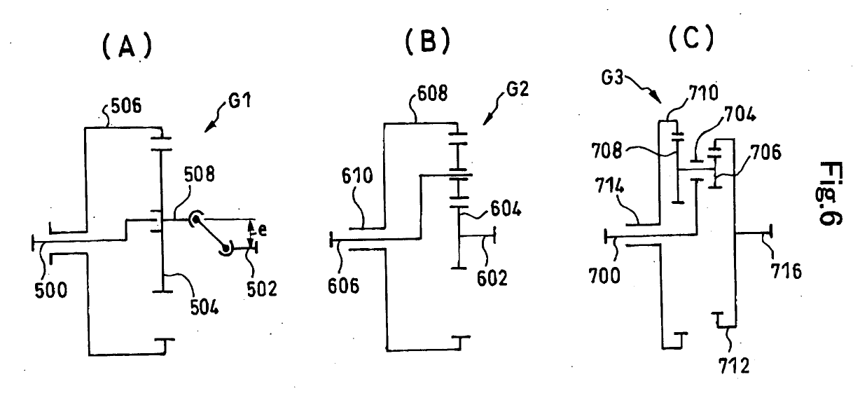

### DETAILED DESCRIPTION OF THE PREFERRED EMBODIMENTS

The following description will describe an example of one embodiment of the invention with reference to the accompanying drawings.

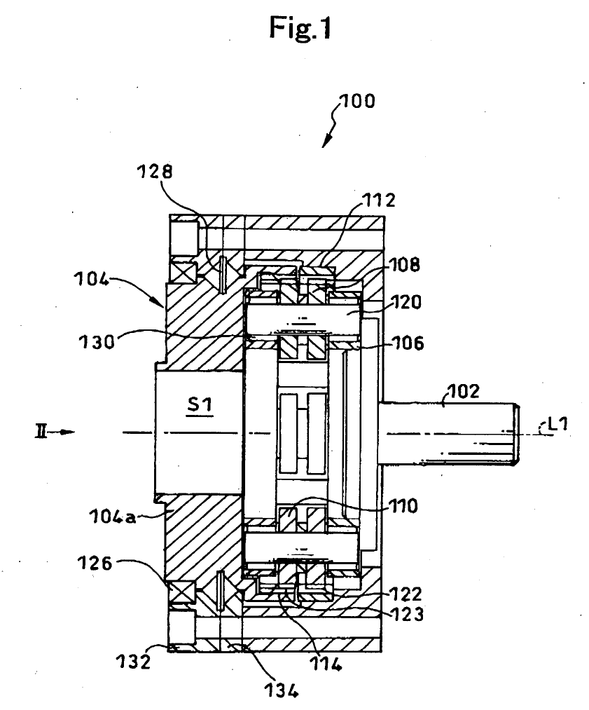

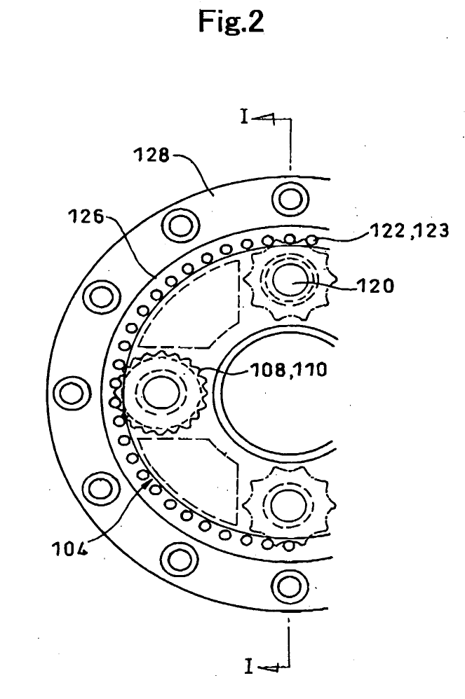

FIG. 1 is a sectional side view of a reduction gear (high-side reduction gear) according to one embodiment of the invention, and FIG. 2 is a front view showing a structure of the high-side reduction gear when viewed from a direction II indicated by an arrow of FIG. 1.

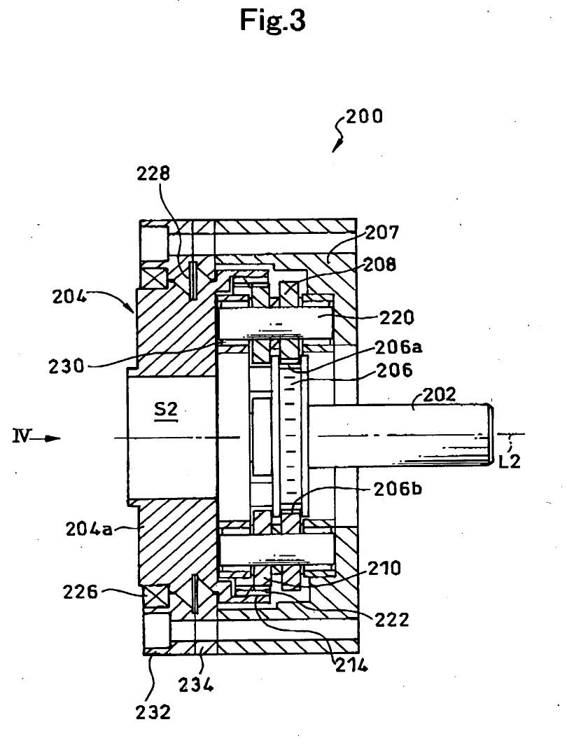

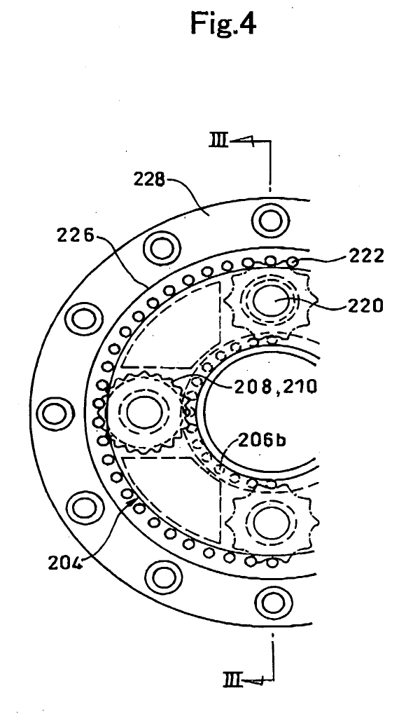

On the other hand, FIG. 3 is sectional side view of a low-side reduction gear forming a series (a product group) of reduction gears according to one embodiment of the invention, and FIG. 4 is a front view showing a structure of the low-side reduction gear when viewed from a direction IV indicated by an arrow of FIG. 3.

A series of reduction gears having these reduction gears as components is arranged in such a manner that a high-side reduction gear 100 is responsible for the region of a high reduction ratio (herein, 1/30 to 1/5) and a low-side reduction gear 200 is responsible for the region of a low reduction ratio (herein, 1/5 to 1/2).

The high-side reduction gear 100 will be explained first in detail with reference to FIG. 1 and FIG. 2.

The high-side reduction gear 100 belongs to a speed reduction mechanism referred to generally as a 2K-H-III type, and chiefly comprises an input shaft 102, a high-side carrier 106 linked to the input shaft 102, high-side first planetary gear 108 and second planetary gear 110 supported by the high-side carrier 106 to be rotatable about the input shaft 102 at the same rotational speed, a high-side first internal gear 112 engaged with the high-side first planetary gear 108 and maintained in a fixed state, a high-side second internal gear 114 engaged with the high-side second planetary gear 110 and linked to an output shaft 104, and the output shaft 104.

The input shaft 102 and the output shaft 104 use a line L1 of FIG. 1 as their respective axial centers, and are placed coaxially.

In this embodiment, the high-side first planetary gear 108 and second planetary gear 110 have an equal number of teeth, and each have a tooth profile of a smooth curve based on a trochoid.

Also, the high-side first planetary gear 108 and second planetary gear 110 are integrated with each other through a carrier pin 120, and supported rotatably by the high-side carrier 106 through a bearing 130.

The high-side first internal gear 112 and second internal gear 114 are provided with a plurality of rotatable pins 122, each of which forms an arc tooth profile.

The high-side second internal gear 114 is integrated with the output shaft 104 on the peripheral rim of a flange portion 104a of the output shaft 104.

The output shaft 104 includes a hollow portion S1, and is supported by a cross roller 128 placed between a front casing 132 and a relay casing 134 to be rotatable with respect to the casings 132 and 134. The flange portion 104a of the output shaft 104 itself serves also as a cover that covers the front surface opening of the high-side reduction gear 100. On the other hand, the input shaft 102 is solid herein. It should be appreciated, however, that it can be readily made hollow depending on its application, and it is also possible to form a hollow space penetrating through the input and output shafts 102 and 104.

An oil seal 126 is disposed between the flange portion 104a of the output shaft 104 and the front casing 132, and it seals oil in the reduction mechanism portion.

A function of the high-side reduction gear 100 will now be explained.

When the input shaft 102 rotates, the high-side carrier 106 linked to the input shaft 102 starts to rotate, which in turn rotates the high-side first planetary gear 108 supported rotatably by the high-side carrier 106. In association with this rotation, the high-side second planetary gear 110 integrated with the first planetary gear 108 through the carrier pin 120 starts to rotate at the same speed. The rotation of the high-side second planetary gear 110 is transmitted to the high-side second internal gear 114, and outputted as being transmitted further to the output shaft 104 integrated with the high-side second internal gear 114.

The low-side reduction gear 200 will now be explained in detail with reference to FIG. 3 and FIG. 4. A detailed explanation will be omitted for the portions structured in the same manner as those in the high-side reduction gear 100 for ease of explanation.

The low-side reduction gear 200 belongs to a reduction mechanism referred to generally as a 2K-H-IV type, and chiefly comprises an input shaft 202, a low-side sun gear 206 linked to the input shaft 202, a low-side carrier 207 maintained in a fixed state, a low-side first planetary gear 208 supported rotatably by the low-side carrier 207 and engaged with the sun gear 206, a low-side second planetary gear 210 also supported rotatably by the low-side carrier 207 and rotating at the same rotational speed of the low-side first planetary gear 208, a low-side internal gear 214 engaged with the low-side second planetary gear 210 and linked to an output shaft 204, and the output shaft 204.

The input shaft 202 and the output shaft 204 use a line L2 of FIG. 3 as their respective axial centers, and are placed coaxially.

In this embodiment, like the high-side first planetary gear 108 and second planetary gear 110 described above, the low-side first planetary gear 208 and second planetary gear 210 have an equal number of teeth, and each have a tooth profile with a smooth curve based on a trochoid. Consequently, these components are designed in such a manner that not only the high-side first planetary gear 108 and the low-side first planetary gear 208 are used commonly, but also the high-side second planetary gear 110 and the low-side second planetary gear 210 are used commonly, and therefore, each can be used commonly in the high-side reduction gear 100 and the low-side reduction gear 200.

The low-side first planetary gear 208 and second planetary gear 210 are integrated with each other through a carrier pin 220, and are supported rotatably by the low-side carrier 207 through a bearing 230.

The sun gear 206 includes a number (as many as teeth) of ring-like grooves 206a on the periphery, and a rotatable pin 206b used to form an arc tooth profile is incorporated in each. Also, by providing the low-side internal gear 214 with a plurality of rotatable pins 222, the same arc tooth profile as that of the high-side second gear 114 described above is formed, and therefore, the low-side internal gear 214 and the high-side second internal gear 114 are designed in such a manner that they can be used commonly in the high-side reduction gear 100 and the low-side reduction gear 200.

The low-side internal gear 214 is integrated with the output shaft 204 on the periphery rim of a flange portion 204a of the output shaft 204.

The output shaft 204 includes a hollow portion S2 (=S1), and is designed in such a manner that it can be used also as the output shaft 104 of the high-side reduction gear 100 described above. As with the input shaft 102 at the high-side, the input shaft 202 can be either solid or hollow.

In this embodiment, the high-side carrier 106 and the low-side carrier 207 are also designed in such a manner that they can be used commonly. A function of the low-side reduction gear 200 will now be explained.

When the input shaft 202 rotates, the sun gear 206 linked to the input shaft 202 starts to rotate, and the low-side first planetary gear 208 starts to rotate in association with the rotation of the sun gear 206. In association with this rotation, the low-side second planetary gear 210 integrated with the low-side first planetary gear 208 through the carrier pin 220 starts to rotate at the same speed. In this embodiment, because the revolution of the carrier pin 220 is limited (fixed), the rotation of the low-side second planetary gear 210 is slowed down for a ratio of the number of teeth of the low-side second planetary gear 210 and those of the low-side internal gear 214, then transmitted to the low-side internal gear 214, and outputted as being transmitted further to the output shaft 204 integrated with the low-side internal gear 214.

In the embodiment of the invention, the high-side reduction gear 100 is adopted for the region of a high reduction ratio (1/30 to 1/5), while the low-side reduction gear 200 is adopted for the region of a low reduction ratio (1/5 to 1/2), and hollow shafts are used as the output shafts 104 and 204 in the respective gears.

According to the above arrangement, it is possible to establish a connection with a mating machine within the output shafts 104 and 204, and a wide space can be secured around the input and output shafts of the reduction gears.

Consequently, it is possible to obtain a series of reduction gears using a hollow shaft as the output shaft, using concentric input and output shafts, and being able to cover a region where a reduction ratio is 1/30 or less.

Also, because the output shaft 104 of the high-side reduction gear 100 and the output shaft 204 of the low-side reduction gear 200, the high-side second internal gear 114 and the low-side internal gear 214, the high-side carrier 106 and the low-side carrier 207, the high-side first planetary gear 108 and the low-side first planetary gear 208, and the high-side second planetary gear 110 and the low-side second planetary gear 210 are made as components that can be used commonly, an increase in variety of components can be minimized, and it is thus possible to design a series with low inventory costs.

In the embodiment above, a tooth profile with a smooth curve based on a trochoid is adopted for the high-side first planetary gear 108 and second planetary gear 110 in the high-side reduction gear 100, and an arc tooth profile is formed on the high-side first internal gear 112 and second internal gear 114 respectively engaged with the high-side first planetary gear 108 and second planetary gear 110 by providing a plurality of rotatable pins 122 and 123, respectively. That the numbers (the numbers of teeth) and the diameters (tooth profile) are slightly different between the pins 122 and 123. The high-side first planetary gear 108 and second planetary gear 110 have an equal number of teeth but have slightly different tooth profiles.

Likewise, the low-side first planetary gear 208 and second planetary gear 210 in the low-side reduction gear 200 have a trochoid tooth profile, and an arc tooth profile is formed on the sun gear 206 and the low-side internal gear 214 respectively engaged with the low-side first planetary gear 208 and second planetary gear 210 by providing a plurality of rotatable pins 206b and 222, respectively.

Consequently, a frictional loss caused by engagement between the trochoid gear and arc gear can be lessened as small as possible, which makes it possible to improve the efficiency of the overall reduction mechanism.

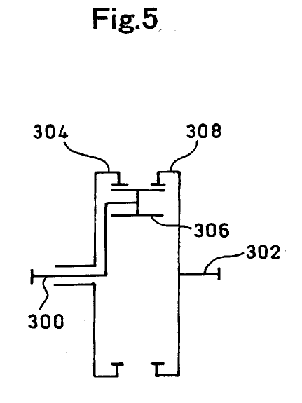

The following description will describe in detail how efficiency is improved with reference to FIG. 5.

FIG. 5 shows one of skeletons of a reduction mechanism referred to generally as a 2K-H type, and this reduction mechanism includes an input shaft 300, an output shaft 302, a driving-end gear 304, an output-end gear 308, and a planetary gear 306 that engages with the driving-end gear 304 and the output-end gear 308.

Let X be efficiency of the overall reduction mechanism, then X can be found in accordance with an equation as follows.

(Equation 1)

$$x = \frac{1 - i}{1 - X1 \times X2 \times i}$$

Herein, X1 is working efficiency between the driving-end gear 304 and the planetary gear 306, X2 is working efficiency between the output-end gear 308 and the planetary gear 306, and i is a reduction ratio (the number of teeth of the output-end gear 308/the number of teeth of the driving-end gear 304).

As can be understood from the equation above, given a constant reduction ratio i, then it is necessary to increase the working efficiencies X1 and X2 in improving the efficiency X of the overall reduction mechanism.

Generally, working efficiency between a pair of gears is a function of a coefficient μ of friction on the tooth flank, which is known to be highly susceptible to a slipping velocity between the tooth flanks. In other words, there is a tendency that the lower the slipping velocity, the greater the coefficient μ of friction on the tooth flank becomes, which results in a reduction of the working efficiency.

Hence, this embodiment adopts the trochoid tooth profile and the arc tooth profile composed of a plurality of rotatable pins instead of the typical involute tooth profile, and coefficient μ of friction on the tooth flank is reduced by increasing the slipping velocity in engagement through the use of rotations of the pins forming the arc tooth profile. A significant advantage can be achieved by, in particular, adopting rotatable pins as the arc tooth profile.

The result of the experiment reveals that when the involute tooth profile is adopted, the coefficient μ of friction on the tooth flank is approximately 0.06 to 0.08, whereas the coefficient μ of friction on the tooth flank is reduced to approximately 0.01 to 0.03 when the trochoid tooth profile and the arc tooth profile are adopted.

Hence, it is understood from the result that, given a constant reduction ratio i (i=0.96), then the efficiency X of the overall reduction mechanism is improved by approximately 24% or more in comparison with the case of having the involute tooth profile.

Further, because slipping in engagement can be absorbed by the rotatable pins 122, 123, 206b and 222, a highly accurate reduction gear such that deteriorates little over time due to friction or the like can be readily manufactured even on a low backlash design.

Because it is arranged in such a manner that: the high-side first planetary gear 108 and the high-side second planetary gear 110 in the high-side planetary gear mechanism have an equal number of teeth; the high-side first and second internal gears 112 and 114 respectively engaged with the high-side first and second planetary gears 108 and 110 have different numbers of teeth; and a set of the high-side first planetary gear 108 and the high-side first internal gear 112 and a set of the high-side second planetary gear 110 and the high-side second internal gear 114 have different tooth profiles (pin diameters), it is still possible to form a so-called magical gear mechanism by adopting a combination of the arc tooth profile and the trochoid tooth profile, which are different from the involute tooth profile in that a shift manipulation is impossible, and a large reduction ratio can be thus obtained. Moreover, as has been described above, efficiency can be improved drastically in comparison with a magical gear mechanism based on the involute tooth profile.

The embodiment above described a series of reduction gears, in which the high-side reduction gear 100 is responsible for the region of a high reduction ratio (1/30 to 1/5) and the low-side reduction gear 200 is responsible for the region of a low reduction ratio (1/5 to 1/2). It should be appreciated that the invention is not limited to the above arrangement, and for example, the high-side reduction gear 100 may be a reduction gear covering the region of a high reduction ratio of 1/30 or above.

In a case where the region for a low reduction ratio is not needed, a series may be formed by the high-side reduction gears 100 alone.

In addition, although the output shaft 104 of the high-side reduction gear 100 and the output shaft 204 of the low-side reduction gear 200, the high-side second internal gear 114 and the low-side second internal gear 214, the high-side carrier 106 and the low-side carrier 207, the high-side first planetary gear 108 and the low-side first planetary gear 208, and the high-side second planetary gear 110 and the low-side second planetary gear 210 are used commonly, not all of these components need to be used commonly.

To be more concrete, a commercially available series of reduction gears generally includes a plurality of reduction gears having different reduction ratios for each frame number (classification of types based on the size or transmissible torque, etc.). Accordingly, it is not necessary for a series of the invention to apply the invention to all the frame numbers, and in some cases, it is sufficient to apply the invention to a part of frame numbers.

According to the invention, it is possible to provide a reduction gear and a series of reduction gears having concentric input and output shafts, capable of securing a large space at the center, and in particular, being highly efficient with the ability to fully cover a region with a reduction ratio of 1/5 to 1/30 or 1/2 to 1/30 as needed.

What is claimed is:

1. A reduction gear, comprising:
an input shaft;
a reduction mechanism for slowing down a rotation of the input shaft; and
an output shaft for outputting the rotation slowed down by the reduction mechanism, wherein:
said output shaft is hollow;
said input shaft and said output shaft are placed coaxially;
said reduction mechanism comprises a planetary gear mechanism including a carrier linked to said input shaft, the carrier being rotatable about the input shaft, a first planetary gear and a second planetary gear supported by the carrier to be rotatable at a same rotational speed with each other, a first internal gear engaged with the first planetary gear and maintained in a fixed state, and a second internal gear engaged with the second planetary gear and linked to said output shaft; and
at least one of the first planetary gear and the second planetary gear has a trochoid tooth profile as a tooth profile, and the internal gear which is engaged with the planetary gear having the trochoid tooth profile has an arc tooth profile.

2. The reduction gear according to claim 1, wherein a rotatable pin is used as the arc tooth profile.

3. The reduction gear according to claim 1, wherein said first planetary gear and said second planetary gear have an equal number of teeth, said first internal gear and said second internal gear have different numbers of teeth, and a set of said first planetary gear and said first internal gear and a set of said second planetary gear and said second internal gear have different tooth profiles.

4. A reduction gear, comprising:
an input shaft;
a reduction mechanism for slowing down a rotation of said input shaft; and
an output shaft for outputting the rotation slowed down by the reduction mechanism, wherein:
said output shaft is hollow;
said input shaft and said output shaft are placed coaxially;
said reduction mechanism comprises a planetary gear mechanism including a carrier linked to said input shaft, the carrier being rotatable about the input shaft, a first planetary gear and a second planetary gear supported by the carrier to be rotatable at a same rotational speed with each other, a first internal gear engaged with the first planetary gear and maintained in a fixed state, and a second internal gear engaged with the second planetary gear and linked to said output shaft; and
at least one of the first planetary gear and the second planetary gears has an arc tooth profile as a tooth profile, and the internal gear which is engaged with the planetary gear having the arc tooth profile has a trochoid tooth profile.

5. The reduction gear according to claim 4, wherein a rotatable pin is used as the arc tooth profile.

6. The reduction gear according to claim 4, wherein said first planetary gear and said second planetary gear have an equal number of teeth, said first internal gear and said second internal gear have different numbers of teeth, and a set of said first planetary gear and said first internal gear and a set of said second planetary gear and said second internal gear have different tooth profiles.

7. A product group of reduction gears including a plurality of reduction gears as a component, wherein:
said product group is divided into a high-side reduction gear responsible for a region of a high reduction ratio and a low-side reduction gear responsible for a region of a low reduction ratio,
said high-side reduction gear comprises a high-side input shaft, a high-side output shaft placed coaxially with the high-side input shaft, the high-side output shaft being hollow, and a high-side planetary gear mechanism, the high-side planetary gear mechanism including a high-side carrier linked to the high-side input shaft, the carrier being rotatable about the high-side input shaft, a high-side first planetary gear and a second high-side planetary gear supported by the high-side carrier to be rotatable at a same rotational speed with each other, a high-side first internal gear engaged with the high-side first planetary gear and maintained in a fixed state, and a high-side second internal gear engaged with the high-side second planetary gear and linked to the high-side output shaft, at least one of the high-side first planetary gear and the second planetary gear having an arc tooth profile as a tooth profile, the high-side internal gear which is engaged with the high-side planetary gear having the arc tooth profile having a trochoid tooth profile, and
said low-side reduction gear comprises a low-side input shaft, a low-side output shaft placed coaxially with the low-side input shaft, the low-side output shaft being hollow, a low-side planetary gear mechanism, the low-side planetary gear mechanism including a low-side sun gear linked to the low-side input shaft, a low-side carrier maintained in a fixed state, a low-side first planetary gear supported rotatably by said low-side carrier and engaged with the low-side sun gear, and a low-side second planetary gear also supported rotatably by the low-side carrier and rotating at a same rotational speed of said low-side first planetary gear, and a low-side internal gear engaged with said low-side second planetary gear and linked to the low-side output shaft.

8. The product group of reduction gears according to claim 7, wherein same output shafts are used commonly in said high-side output shaft and said low-side output shaft.

9. The product group of reduction gears according to claim 7, wherein same internal gears are used commonly in said high-side second internal gear and said low-side internal gear.

10. The product group of reduction gears according to claim 7, wherein same carriers are used commonly in said high-side carrier and said low-side carrier.

11. The product group of reduction gears according to claim 7, wherein same planetary gears are used commonly in said high-side first planetary gear and said low-side first planetary gear.

12. The product group of reduction gears according to claim 7, wherein same planetary gears are used commonly in said high-side second planetary gear and said low-side second planetary gear.
